(19) United States
(12) Patent Application Publication
(10) Pub. No.: US 2018/0339704 A1
(43) Pub. Date: Nov. 29, 2018

(54) METHOD FOR PREPARING EMERGENCY BRAKING OF VEHICLE

(71) Applicant: HYUNDAI MOBIS CO., LTD., Seoul (KR)

(72) Inventors: Hwan Seong JO, Yongin-si (KR); Yong Kwan JI, Seoul (KR)

(21) Appl. No.: 15/977,560

(22) Filed: May 11, 2018

(30) Foreign Application Priority Data
May 29, 2017 (KR) 10-2017-0065948

(51) Int. Cl. B60W 30/09; B60W 30/095; B60W 30/18

(52) U.S. Cl. CPC B60W 30/09; B60W 30/0956; B60W 2420/403; B60W 2550/10; B60W 2510/182; B60W 30/181

(57) ABSTRACT

A method for preparing emergency braking of a vehicle including receiving information regarding a traveling route of the vehicle or a road and nearby information, by a controller; checking, based on the received information, whether a current traveling section is a section in which predetermined deceleration information exists; setting a braking pressure to a predetermined level 1 (LV1) preparation state, in the case where a current traveling section is a section in which predetermined deceleration information exists; detecting at least one pedestrian-related information around the road by processing an image photographed using a camera, by the controller; and calculating a risk of collision with a pedestrian in a predetermined scheme by the controller when the pedestrian-related information is checked, and setting a braking pressure to a predetermined level 2 (LV2) preparation state in the case where the risk of collision is greater than a preset reference.

### CROSS REFERENCE TO RELATED APPLICATION

This application claims priority from and the benefit of Korean Patent Application No. 10-2017-0065948, filed on May 29, 2017, which is hereby incorporated by reference for all purposes as if set forth herein.

### BACKGROUND

### Field

Exemplary embodiments relate to a method for preparing emergency braking of a vehicle, and more particularly, to a method for preparing emergency braking of a vehicle, wherein information on a section in which a pedestrian is likely to rush in front of a vehicle on a route that the vehicle is traveling or is about to travel is obtained in advance and a braking pressure is boosted stepwise in advance depending on the probability of the pedestrian to rush to the vehicle so that an emergency braking time may be shortened.

### Discussion of the Background

In general, an autonomous emergency brake which is also referred to as an emergency braking assist system means a smart safety system which automatically recognizes an object or a pedestrian in front of a vehicle and actively activates a brake when a collision is anticipated in front, to thereby mitigate damage.

The autonomous emergency brake autonomously analyzes a situation ahead of a camera or a radar mounted to the vehicle, and, when a driver does not actively take an action, reduces a speed or stops by means of a brake based on a time-to-collision (TTC) with respect to a preceding vehicle and a relative speed of the preceding vehicle and the following vehicle.

In general, the autonomous emergency brake outputs warnings to a user (the driver) in a stepwise manner in advance. In this regard, ‘observing front’ is outputted as a first warning, ‘beware collision’ is outputted as a second warning and ‘emergency braking’ is outputted as a third warning. In the case where an automatic sensor senses the front and detects a risk of collision, a steering wheel vibrates or sounds before an expected collision time (e.g.: 1.8 seconds) and outputs a warning to the driver, and, in the case where the driver does not take an action, the autonomous emergency brake intervenes in an emergency braking system and forcibly actuates the brake.

In the autonomous emergency brake, in the case where a target with a high probability of collision in front of the vehicle is detected ahead of at least a predetermined distance, it is possible to take stepwise countermeasures, such as outputting a warning and then forcibly actuating the brake. However, in the case where a target is not detected in advance ahead of at least the predetermined distance and suddenly appears (or rushes) in front of the vehicle, the brake should be actuated immediately.

In this case (that is, in the case where a target suddenly appears (or rushes) in front of the traveling vehicle and thus the brake should be actuated immediately), a problem may be caused in that braking performance deteriorates due to a typical time delay required to boost a braking pressure.

Therefore, not only is it necessary to detect a target with a high probability of collision by using a sensor mounted to the vehicle, but it is also necessary to obtain, in advance, information on a section in which a pedestrian is likely to rush in front of the vehicle and boost a braking pressure stepwise in advance when traveling the corresponding section (that is, the section with high probability for a pedestrian to rush) so that a time delay required to boost the braking pressure does not occur and thus, an emergency braking time may be shortened.

The above information disclosed in this Background section is only for enhancement of understanding of the background of the invention and, therefore, it may contain information that does not constitute prior art.

### SUMMARY

Exemplary embodiments of the invention provide a method for preparing emergency braking of a vehicle, wherein information on a section in which a pedestrian is likely to rush in front of a vehicle on a route that the vehicle is traveling or is about to travel is obtained in advance and a braking pressure is boosted stepwise in advance depending on the probability of the pedestrian to rush to the vehicle so that an emergency braking time may be shortened.

Additional features of the invention will be set forth in the description which follows, and in part will be apparent from the description, or may be learned by practice of the invention.

An exemplary embodiment of the invention provides a method for preparing emergency braking of a vehicle including: receiving information regarding a traveling route of the vehicle or a road and nearby information, by a control unit; checking, based on the received information, whether a current traveling section is a section in which predetermined deceleration information exists, by the control unit; setting a braking pressure to a predetermined level 1 (LV1) preparation state, by the control unit, in the case where a current traveling section is a section in which predetermined deceleration information exists; detecting at least one pedestrian-related information around the road by processing an image photographed using a camera, by the control unit; and calculating a risk of collision with a pedestrian in a predetermined scheme by the control unit when the pedestrian-related information is checked, and setting a braking pressure to a predetermined level 2 (LV2) preparation state in the case where the risk of collision is greater than a preset reference.

Another exemplary embodiment of the invention provides a method for preparing emergency braking of a vehicle including: photographing information on a traveling route of the vehicle or a road and nearby information by using a camera, and detecting at least one pedestrian-related information around the road by processing a photographed image, by the control unit; checking, when the pedestrian-related information is checked, whether the number of pedestrians is larger than a predetermined threshold number and an exposure time is longer than a predetermined threshold time, by the control unit; setting, when, as a result of the checking, the number of pedestrians is greater than the predetermined threshold number and an exposure time is longer than the predetermined threshold time, a braking pressure to a predetermined level 1 (LV1) preparation state, by the control unit; and calculating a risk of collision with a pedestrian in a predetermined scheme by the control unit, based on the checked pedestrian-related information, and setting a braking pressure to a predetermined level 2 (LV2) preparation state in the case where the risk of collision is larger than a preset reference.

Another exemplary embodiment of the invention provides a method for preparing emergency braking of a vehicle including: receiving information regarding a traveling route of the vehicle or a road and nearby information, by a control unit; checking, based on the received information, whether a current traveling section is a section in which predetermined deceleration information exists, by the control unit; setting a braking pressure to a predetermined level 1 (LV1) preparation state, by the control unit, in the case where a current traveling section is a section in which predetermined deceleration information exists; photographing information regarding a traveling route of the vehicle or a road and nearby information by using a camera and detecting at least one pedestrian-related information around the road by processing a photographed image, by the control unit, in the case where a current traveling section is not a section in which predetermined deceleration information exists; checking, when the pedestrian-related information is checked, whether the number of pedestrians is greater than a predetermined threshold number and an exposure time is longer than a predetermined threshold time, by the control unit; setting, when, as a result of the checking, the number of pedestrians is greater than the predetermined threshold number and an exposure time is longer than the predetermined threshold time, a braking pressure to a predetermined level 1 (LV1) preparation state, by the control unit; and calculating a risk of collision with a pedestrian in a predetermined scheme by the control unit, based on the checked pedestrian-related information, and setting a braking pressure to a predetermined level 2 (LV2) preparation state in the case where the risk of collision is larger than a preset reference.

According to the embodiments, information on a section in which a pedestrian is likely to rush in front of a vehicle on a route that the vehicle is traveling or is about to travel is obtained in advance and a braking pressure is boosted stepwise in advance depending on the probability of the pedestrian to rush to the vehicle so that an emergency braking time may be shortened.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exemplary view illustrating the schematic construction of an apparatus for preparing emergency braking of a vehicle in accordance with an exemplary embodiment of the invention.

FIG. 2 is a flow chart describing a method for preparing emergency braking of a vehicle in accordance with an exemplary embodiment of the invention.

FIG. 3 is an exemplary view explaining a method for detecting pedestrian-related information around a road by using a camera sensor according to an exemplary embodiment of the invention.

FIG. 4 is a flow chart describing a method for preparing emergency braking of a vehicle in accordance with an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

As is customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Hereinafter, a method for preparing emergency braking of a vehicle will be described below with reference to the accompanying drawings through various exemplary embodiments.

It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

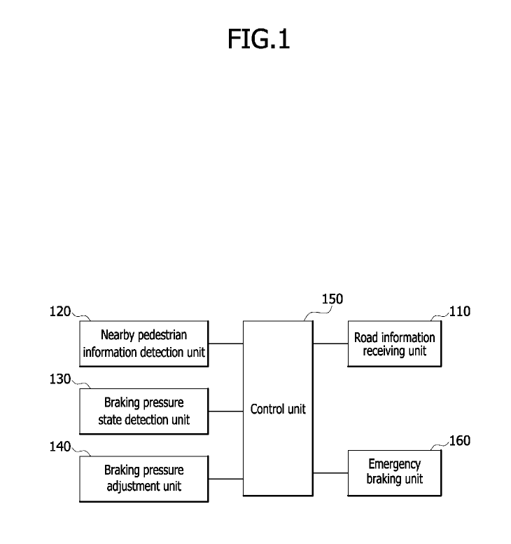

FIG. 1 is an exemplary view illustrating the schematic construction of an apparatus for preparing emergency braking of a vehicle in accordance with an exemplary embodiment of the invention.

As shown in FIG. 1, the apparatus for preparing emergency braking of a vehicle in accordance with the present exemplary embodiment includes a road information receiving unit 110, a nearby pedestrian information detection unit 120, a braking pressure state detection unit 130, a braking pressure adjustment unit 140, a control unit 150 and an emergency braking unit 160.

The road information receiving unit 110 receives information on a route (or a road) on which the vehicle travels and nearby information on the route.

The road information receiving unit 110 receives the information on a route (or a road) and the nearby information on the route from a navigation device (not shown) mounted to the vehicle or a navigation server (e.g.: a way guide server) (not shown) coupled thereto through wireless communication.

The information on a route (or a road) and the nearby information on the route not only means simply travel speed limit information by location but also includes at least one pedestrian-related statistical information among statistical information on the number of pedestrians by day of the week and time slot, statistical information on the average age of pedestrians and statistical information on traffic accidents.

Therefore, the road information receiving unit 110 may communicate with at least one server (e.g.: a traffic accident information providing server, a statistical information providing server, etc.) which provides another type of information, in addition to the navigation server (e.g.: a way guide server).

The nearby pedestrian information detection unit 120 detects, in particular, pedestrian information, among information around the road, by using a sensor mounted to the vehicle and by sensing information around a point of the road on which the vehicle is currently traveling.

The nearby pedestrian information detection unit 120 detects front pedestrians and front side pedestrians who are within a predetermined distance from a current point of the road on which the vehicle is traveling, by using a camera sensor mounted to the vehicle.

For example, the nearby pedestrian information detection unit 120 photographs a nearby situation by using the camera sensor, and recognizes pedestrians (front pedestrians and front side pedestrians who are within a predetermined distance from a current point of the road), by processing a photographed image. Of course, the nearby pedestrian information detection unit 120 may simply photograph a nearby situation, and the control unit 150 may recognize pedestrians (front pedestrians and front side pedestrians who are within a predetermined distance from a current point of the road), by processing a photographed image.

Also, the nearby pedestrian information detection unit 120 and the control unit 150 may check the number information and exposure time information of the recognized pedestrians.

In the case where the number of pedestrians photographed within one frame of an image is too large, it is practically not easy to count the number of pedestrians in a short time and a large load is consumed. Therefore, in the case where pedestrians in a photographed image are not individually separated and overlap with one another or are stuck together, the number of pedestrians is not directly counted. Thus, the exposure time information as information that permits to know how many pedestrians are present closely on a sidewalk may be a concept that includes length information of a kind of close pedestrians (that is, pedestrians whose intervals of individual pedestrians are shorter than a specified distance).

The braking pressure state detection unit 130 detects a current braking pressure state (e.g.: a brake fluid pressure).

For example, the braking pressure state detection unit 130 may detect a current braking pressure state by converting it into a percentage when assuming that a state where a wheel is completely braked and does not rotate is 100% as a reference.

The braking pressure adjustment unit 140 adjusts the braking pressure of a brake (e.g.: a brake fluid pressure) to a specified percentage according to the control of the control unit 150. It is to be noted that an actuator for adjusting the braking pressure may be changed depending on a braking scheme of the brake.

When a driver does not take an action despite that stepwise warnings are outputted as a target (e.g.: a pedestrian, an obstacle, an animal, etc.) that has been being watched rushes in front of the traveling vehicle, the emergency braking unit 160 forcibly actuates the brake in the case where a time for the driver to take an action when a target rushes with stepwise warnings not outputted is shorter than a predetermined time (e.g.: a statistical time from recognition of the target to stepping on a brake pedal).

While the functions of the above-described components 110 to 160 have been described separately from one another to facilitate clear understanding of the operation of the present exemplary embodiment, it is to be noted that, in other exemplary embodiments, the control unit 150 may perform the functions of the components 110 to 160 in an integrated manner or the control unit 150 may perform the functions of the components 110 to 160 by replacing at least one of the functions with another function.

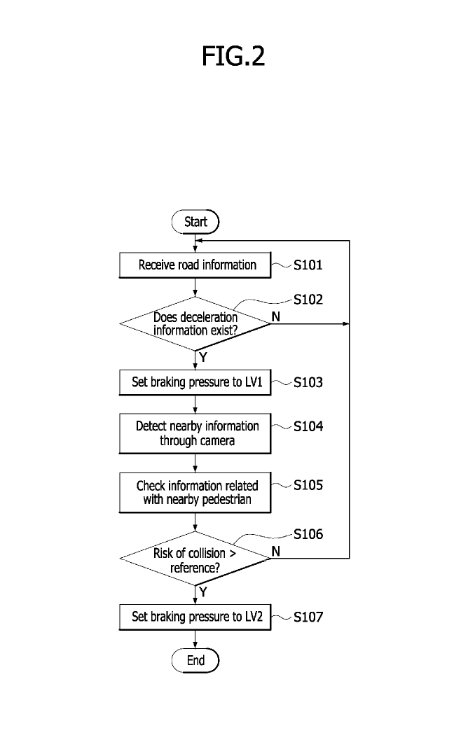

FIG. 2 is a flow chart describing a method for preparing emergency braking of a vehicle in accordance with an exemplary embodiment of the invention.

As shown in FIG. 2, the control unit 150 receives information on a route (or a road) on which the vehicle travels and nearby information on the route, from a navigation device (not shown) mounted to the vehicle or at least one server (e.g.: a way guide server, a traffic accident information providing server, a statistical information providing server, etc.) which is coupled thereto through wireless communication and provides specified information (S101).

The information on a route (or a road) and the nearby information on the route not only means simply travel speed limit information by location but also includes at least one pedestrian-related statistical information among statistical information on the number of pedestrians by day of the week and time slot, statistical information on the average age of pedestrians and statistical information on traffic accidents.

Based on the information on a route (or a road) and the nearby information on the route which are received, the control unit 150 checks whether preset deceleration information exists or not (S102).

The deceleration information means information which is provided to prepare for a traffic accident (for example, information which guides decelerated traveling to enable emergency braking or minimize impact when a traffic accident occurs) because there is a risk of a traffic accident.

Thus, the deceleration information includes information determined based on a travel speed limit specified in advance for a school or a road construction zone, and information provided for a section with relatively high probability of an accident to occur, based on the statistical information in the present exemplary embodiment (e.g.: statistical information on the number of pedestrians by day of the week and time slot, statistical information on the average age of pedestrians and statistical information on traffic accidents).

As a result of checking at the step S102, in the case where deceleration information exists for a corresponding traveling section (Y of the step S102), the control unit 150 sets a braking pressure to a level 1 (LV1) preparation state (S103).

The level 1 preparation state of a braking pressure means that a braking pressure is boosted to a predetermined level 1 (e.g.: 30%) preparation state when a braking pressure of 100% serves as a reference.

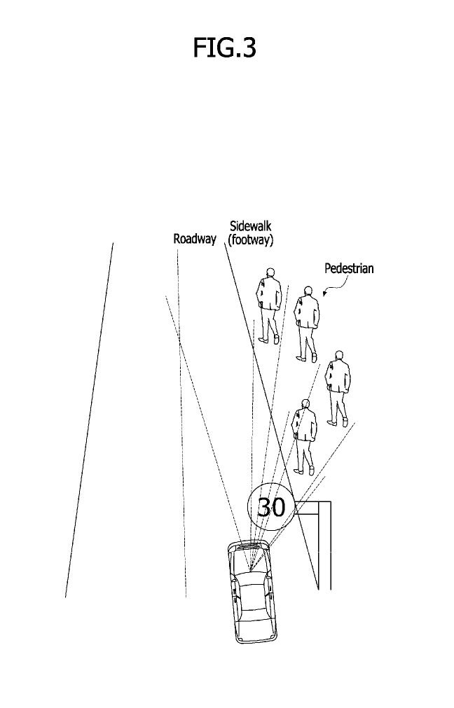

Further, as shown in FIG. 3, the control unit 150 detects nearby information (e.g.: information on a pedestrian, an obstacle, an animal, etc.) through the nearby pedestrian information detection unit 120 (or a camera sensor) (S104).

While it is illustrated in the drawing for the sake of convenience in explanation that, after a braking pressure is boosted to the predetermined level 1 (e.g.: 30%) preparation state, the nearby information is detected at the next step S104, this is nothing but an illustration purpose only. In this regard, it is to be noted that, in other exemplary embodiments, a preparation state of a braking pressure may be implemented regardless of setting it to the level LV1 at the step S103.

The control unit 150 photographs a nearby situation by using the nearby pedestrian information detection unit 120 (or the camera sensor) as described above, recognizes pedestrians (front pedestrians and front side pedestrians who are within a predetermined distance from a current point of the road), by processing a photographed image, and checks pedestrian-related information around a road (e.g.: a sidewalk) such as the number information and exposure time information of the recognized pedestrians.(S105).

In the case where the number of pedestrians photographed within one frame of an image is too large, it is practically not easy to count the number of pedestrians in a short time and a large load is consumed. Therefore, in the case where pedestrians in a photographed image are not individually separated and overlap with one another or are stuck together, the number of pedestrians is not directly counted. Thus, the exposure time information as information that permits to know how many pedestrians are present closely on a sidewalk may be a concept that includes length information of a kind of close pedestrians (that is, pedestrians whose intervals of individual pedestrians are shorter than a specified distance).

If the pedestrian-related information is checked as described above, the control unit 150 calculates a risk of collision (that is, the probability of a pedestrian to rush into a route of the vehicle or a pedestrian variation index), and, in the case where the risk of collision is larger than a predetermined reference (Y of step S106), the control unit 150 sets a braking pressure to a level 2 (LV2) preparation state (S107).

The level 2 preparation state of a braking pressure means that a braking pressure is boosted to a predetermined level 2 (e.g.: 60%) preparation state when a braking pressure of 100% serves as a reference. In detail, the LV1 and LV2 preparation states mean not a state of braking a brake but a state of preparing for braking in a boosted state. In other words, the LV1 and LV2 preparation states mean a state for boosting a braking pressure immediately after the LV1 and LV2 preparation states (for example, after the braking pressure of 30% or after the braking pressure of 60%) in the case of performing emergency braking.

Accordingly, it is possible to further shorten an emergency braking time in comparison with an existing emergency braking time, whereby it is possible to further prevent a pedestrian collision accident.

Meanwhile, the risk of collision (that is, the probability of a pedestrian to rush into a route of the vehicle or a pedestrian variation index) may be calculated using, for example, a*fn (number of adults, moving speed)+1.5a*fn (number of children, moving speed). In the expression, a as weight information means that a risk of collision for a child is higher than that for an adult, and the function fn means that a risk of collision is calculated by differently reflecting the moving speed of an adult and the moving speed of a child. For reference, an adult and a child are classified based on the heights of respective pedestrians in a photographed image.

In the above-described exemplary embodiment, an emergency braking preparation method of a vehicle is explained in the case where deceleration information exists, and the deceleration information is information predetermined based on a place (for example, a school, a kindergarten, etc.) on a map. However, an actual road situation may be variable. For instance, there may be a situation in which the number of pedestrians temporarily increases by an observance or an event (e.g.: a walking event, a demonstration, a festival, etc.) at a certain place.

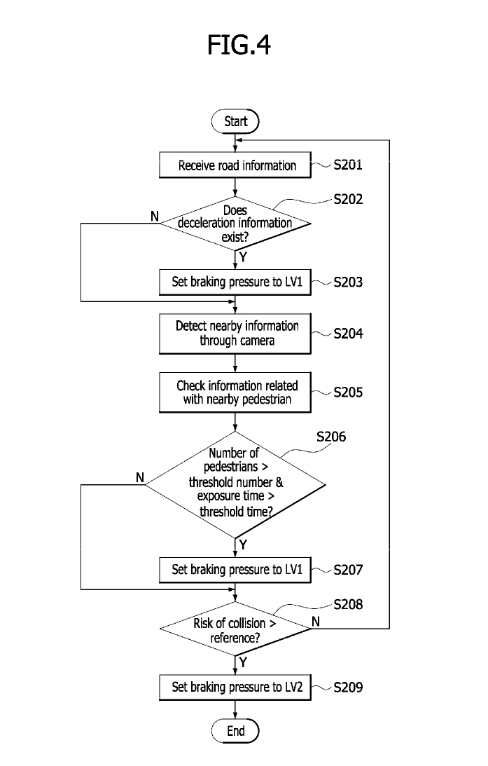

Therefore, it is necessary to set a braking pressure preparation state by calculating a risk of collision based on the number of pedestrians and an exposure time through monitoring a nearby situation although deceleration information is not received, in the unspecified situation as described above. This will be described below in detail with reference to FIG. 4.

FIG. 4 is a flow chart describing a method for preparing emergency braking of a vehicle in accordance with an exemplary embodiment of the invention.

As shown in FIG. 4, the control unit 150 receives information on a route (or a road) on which the vehicle travels and nearby information on the route, from a navigation device (not shown) mounted to the vehicle or at least one server (e.g.: a way guide server, a traffic accident information providing server, a statistical information providing server, etc.) which is coupled thereto and provides specified information (S201).

Based on the information on a route (or a road) and the nearby information on the route which are received, the control unit 150 checks whether preset deceleration information exists or not (S202).

As a result of checking at the step S202, in the case where deceleration information exists for a corresponding traveling section (Y of the step S202), the control unit 150 sets a braking pressure to a level 1 (LV1) preparation state (S203).

However, as a result of checking at the step S202, in the case where deceleration information does not exist for a corresponding traveling section (N of the step S202), the control unit 150 detects nearby information (e.g.: information on a pedestrian, an obstacle, an animal, etc.) through only the nearby pedestrian information detection unit 120 (or a camera sensor) (S204).

The control unit 150 recognizes pedestrians (front pedestrians and front side pedestrians who are within a predetermined distance from a current point of the road), by processing an image photographed through the nearby pedestrian information detection unit 120 (or the camera sensor), and checks pedestrian-related information around a road (e.g.: a sidewalk) such as the number information and exposure time information of the recognized pedestrians.(S205).

In the case where the number of pedestrians photographed within one frame of an image is too large, it is practically not easy to count the number of pedestrians in a short time and a large load is consumed. Therefore, in the case where pedestrians in a photographed image are not individually separated and overlap with one another or are stuck together, the number of pedestrians is not directly counted. Thus, the exposure time information as information that permits to know how many pedestrians are present closely on a sidewalk may be a concept that includes length information of a kind of close pedestrians (that is, pedestrians whose intervals of individual pedestrians are shorter than a specified distance).

If the pedestrian-related information is checked as described above, the control unit 150 checks whether the number of pedestrians is larger than a predetermined threshold number and an exposure time is longer than a predetermined threshold time (S206).

As a result of checking at the step S206, in the case where the number of pedestrians is larger than the predetermined threshold number and an exposure time is longer than the predetermined threshold time (Y of the step S206), the control unit 150 sets a braking pressure to a level 1 (LV1) preparation state (S207).

Based on the pedestrian-related information checked at the step S205, the control unit 150 calculates a risk of collision (that is, the probability of a pedestrian to rush into a route of the vehicle or a pedestrian variation index), and, in the case where the risk of collision is larger than a predetermined reference (Y of step S208), the control unit 150 sets a braking pressure to a level 2 (LV2) preparation state (S208).

While it is illustrated in the drawing for the sake of convenience in explanation that, in the case where the number of pedestrians is not larger than the predetermined threshold number and an exposure time is not longer than the predetermined threshold time (N of the step S206), the step S208 in which a risk of collision is calculated and whether the risk of collision is larger than the predetermined reference is checked is performed, this is nothing but an illustration purpose only. In this regard, it is to be noted that, in other exemplary embodiments, the step S208 may be performed immediately when the pedestrian-related information is checked at the step S205, regardless of the step S206.

As described above, according to the present exemplary embodiment, pedestrian-related information is checked using the nearby pedestrian information detection unit 120 (or the camera sensor) regardless of whether deceleration information exists or not, and a braking pressure is boosted in advance depending on the probability of a pedestrian to rush into a route of the vehicle (that is, a risk of collision) such that a braking time may be shortened when performing emergency braking, whereby it is possible to prevent a pedestrian collision accident from occurring.

Although exemplary embodiments of the present disclosure have been shown and described hereinabove, the present disclosure is not limited to specific exemplary embodiments described above, but may be various modified by those skilled in the art to which the present disclosure pertains without departing from the scope and spirit of the disclosure as disclosed in the accompanying claims. In addition, such modifications should also be understood to fall within the scope and spirit of the present disclosure.

What is claimed is:

1. A method for preparing emergency braking of a vehicle, comprising:
receiving information regarding a traveling route of the vehicle or a road and nearby information, by a controller;
checking, based on the received information, whether a current traveling section is a section in which predetermined deceleration information exists, by the controller;
setting a braking pressure to a predetermined level 1 (LV1) preparation state, by the controller, in the case where a current traveling section is a section in which predetermined deceleration information exists;
detecting at least one pedestrian-related information around the road by processing an image photographed using a camera, by the controller; and
calculating a risk of collision with a pedestrian in a predetermined scheme by the controller when the pedestrian-related information is checked, and setting a braking pressure to a predetermined level 2 (LV2) preparation state in the case where the risk of collision is greater than a preset reference.

2. The method according to claim 1, wherein the information regarding a traveling route of the vehicle or a road and the nearby information are received from a navigation device mounted to the vehicle or at least one server which is coupled to the controller through wireless communication and provides specified information.

3. The method according to claim 1, wherein the deceleration information is information which is provided in order to guide decelerated traveling to enable emergency braking to be performed in preparation for a risk of occurrence of a traffic accident or minimize impact even when a traffic accident occurs.

4. The method according to claim 1, wherein the deceleration information includes information determined based on a travel speed limit specified in advance for a school or a road construction section and information provided for a section with relatively high probability of an accident to occur, based on predetermined statistical pedestrian information, and the statistical pedestrian information includes at least one among statistical information regarding the number of pedestrians by day of week and time slot, statistical information regarding an average age of pedestrians, and statistical information regarding traffic accidents.

5. The method according to claim 1, wherein the information regarding a traveling route of the vehicle or a road and the nearby information include at least one pedestrian-related statistical information among statistical information regarding the number of pedestrians by day of week and time slot, statistical information on an average age of pedestrians, and statistical information on traffic accidents.

6. The method according to claim 1, wherein the level 1 preparation state is a preparation state in which a braking pressure is boosted to the predetermined level 1 preparation state when a braking pressure in a state where a wheel is completely braked is 100% as a reference.

7. The method according to claim 1, wherein the detecting of the pedestrian-related information around the road comprises:
recognizing front pedestrians and front side pedestrians who are within a predetermined distance from a current point on the road, by processing the photographed image, by the controller; and
checking at least one pedestrian-related information between number information and exposure time information of the recognized pedestrians.

8. The method according to claim 1, wherein the exposure time information, as information that permits knowing how many pedestrians are present closely on a sidewalk in the case where pedestrians in the photographed image are not individually separated and overlap with one another or are stuck together, is information including length information regarding pedestrians in which intervals between individual pedestrians are less than a specified distance.

9. The method according to claim 1, wherein the level 2 preparation state, as a preparation state in which a braking pressure is boosted to the predetermined level 2 preparation state when a braking pressure in a state where a wheel is completely braked is 100% as a reference, is a braking pressure preparation state higher than the level 1 preparation state.

10. The method according to claim 1, wherein the risk of collision is a pedestrian variation index for a probability of a pedestrian to rush into a route of the vehicle; and the controller classifies a child and an adult based on height in the photographed image and calculates risks of collision by applying weights to the adult and the child such that the risk of collision for the child is calculated to be higher than the risk of collision for the adult.

11. A method for preparing emergency braking of a vehicle, comprising:
photographing information regarding a traveling route of the vehicle or a road and nearby information by using a camera, and detecting at least one pedestrian-related information around the road by processing a photographed image, by the controller;
checking, when the pedestrian-related information is checked, whether the number of pedestrians is greater than a predetermined threshold number and an exposure time is longer than a predetermined threshold time, by the controller;
setting, when, as a result of the checking, the number of pedestrians is greater than the predetermined threshold number and an exposure time is longer than the predetermined threshold time, a braking pressure to a predetermined level 1 (LV1) preparation state, by the control unit; and
calculating a risk of collision with a pedestrian in a predetermined scheme by the control unit, based on the checked pedestrian-related information, and setting a braking pressure to a predetermined level 2 (LV2) preparation state in the case where the risk of collision is greater than a preset reference.

12. The method according to claim 11, wherein:
the level 1 preparation state is a preparation state in which a braking pressure is boosted to the predetermined level 1 preparation state when a braking pressure in a state where a wheel is completely braked is 100% as a reference; and
the level 2 preparation state, as a preparation state in which a braking pressure is boosted to the predetermined level 2 preparation state when a braking pressure in a state where a wheel is completely braked is 100% as a reference, is a braking pressure preparation state higher than the level 1 preparation state.

13. The method according to claim 11, wherein the detecting of the pedestrian-related information around the road comprises:
recognizing front pedestrians and front side pedestrians who are within a predetermined distance from a current point on the road, by processing the photographed image, by the controller; and
checking at least one pedestrian-related information between number information and exposure time information of the recognized pedestrians.

14. The method according to claim 11, wherein the exposure time information, as information that permits knowing how many pedestrians are present closely on a sidewalk in the case where pedestrians in the photographed image are not individually separated and overlap with one another or are stuck together, is information including length information regarding close pedestrians in which intervals between individual pedestrians are less than a specified distance.

15. The method according to claim 11, wherein the risk of collision is a pedestrian variation index for a probability of a pedestrian to rush into a route of the vehicle; and the control unit classifies a child and an adult based on height in the photographed image and calculates risks of collision by applying weights to the adult and the child such that the risk of collision for the child is calculated to be greater than the risk of collision for the adult.

16. A method for preparing emergency braking of a vehicle, comprising:
receiving information regarding a traveling route of the vehicle or a road and nearby information, by a controller;
checking, based on the received information, whether a current traveling section is a section in which predetermined deceleration information exists, by the controller;
setting a braking pressure to a predetermined level 1 (LV1) preparation state, by the controller, in the case where a current traveling section is a section in which predetermined deceleration information exists;
photographing information regarding a traveling route of the vehicle or a road and nearby information by using a camera and detecting at least one pedestrian-related information around the road by processing a photographed image, by the controller, in the case where a current traveling section is not a section in which predetermined deceleration information exists;
checking, when the pedestrian-related information is checked, whether the number of pedestrians is greater than a predetermined threshold number and an exposure time is longer than a predetermined threshold time, by the controller;
setting, when, as a result of the checking, the number of pedestrians is greater than the predetermined threshold number and an exposure time is longer than the predetermined threshold time, a braking pressure to a predetermined level 1 (LV1) preparation state, by the controller; and
calculating a risk of collision with a pedestrian in a predetermined scheme by the controller, based on the checked pedestrian-related information, and setting a braking pressure to a predetermined level 2 (LV2) preparation state in the case where the risk of collision is greater than a preset reference.
